(19) United States
(12) Patent Application Publication
(10) Pub. No.: US 2022/0213647 A1
(43) Pub. Date: Jul. 7, 2022

(54) PRINTING FLUIDS WITH BLOCKED POLYISOCYANTE CROSSLINKERS

(71) Applicant: Hewlett-Packard Development Company, L.P., Spring, TX (US)

(72) Inventors: Dennis Z. GUO, San Diego, CA (US); Jie ZHENG, San Diego, CA (US)

(73) Assignee: Hewlett-Packard Development Company, L.P., Spring, TX (US)

(21) Appl. No.: 17/430,470

(22) PCT Filed: Nov. 25, 2019
(86) PCT No.: PCT/US2019/062916

§ 371 Date: Aug. 12, 2021

(51) Int. Cl. D06P 5/30; C09D 11/38; C09D 11/322; D06P 1/52; D06P 1/54; D06P 5/20

(52) U.S. Cl. CPC D06P 5/30; C09D 11/38; D06P 5/2077; D06P 1/5285; D06P 1/54; C09D 11/322

(57) ABSTRACT

A printing fluid can include from 50 wt % to 90 wt % water, from 4 wt % to 25 wt % organic co-solvent, and from 0.1 wt % to 8 wt % blocked polyisocyanate crosslinker having multiple isocyanate groups that are blocked with benzyl amine blocking groups having the structure of Formula (I). In Formula (I), R¹ can independently be C₁-C₆-alkyl or C₆-C₁₀-cycloalkyl; R² can be H, C₁-C₆-alkyl, or C₆-C₁₀-cycloalkyl; R³ can be H, C₁-C₆-alkyl, or C₆-C₁₀-cycloalkyl; R⁴ can be C₁-C₆-alkyl or C₆-C₁₀-cycloalkyl; and n can be from 0 to 5.

### BACKGROUND

Inkjet printing has become a popular way of recording images on various media. Some of the reasons include low printer noise, variable content recording, capability of high speed recording, and multi-color recording. These advantages can be obtained at a relatively low price to consumers. As the popularity of inkjet printing increases, the types of use also increase providing demand for new ink compositions. In one example, textile printing can have various applications including the creation of signs, banners, artwork, apparel, wall coverings, window coverings, upholstery, pillows, blankets, flags, tote bags, clothing, etc.

### BRIEF DESCRIPTION OF DRAWINGS

FIG. 1 schematically depicts the example printing fluid, which in this example is an ink composition including a dispersed pigment, a polyurethane binder, and a blocked polyisocyanate crosslinker in accordance with the present disclosure;

FIG. 2 schematically depicts the example ink composition and example crosslinker composition, wherein the ink composition can include a dispersed pigment and a polyurethane binder, and the crosslinker composition includes a blocked polyisocyanate in accordance with the present disclosure;

FIG. 3 is a flow diagram illustrating an example method of textile printing in accordance with the present disclosure;

FIG. 4 depicts an example system that can be used in carrying out the method of textile printing of FIG. 3 in accordance with the present disclosure; and

FIG. 5 depicts another example system that can also be used in carrying out the method of textile printing of FIG. 3 in accordance with the present disclosure.

### DETAILED DESCRIPTION

The present technology relates to printing fluids, such as ink compositions and/or crosslinker compositions with a blocked polyisocyanate crosslinker contained therein, or fluid sets including ink compositions and a separate jettable fluid containing the blocked polyisocyanate crosslinker. The blocked polyisocyanate crosslinker includes multiple isocyanate groups that are blocked with benzyl amine blocking groups. The ink composition (with or without the crosslinker) and the separate crosslinker composition, where applicable, can include a predominant amount of water, as well as other liquid vehicle components, such as organic co-solvent, surfactant, etc. The ink compositions as described herein also include dispersed pigment and polyurethane binder. In some examples, these ink compositions and fluid sets are effective for printing on fabric substrates in particular, though they can be printed on any of a number of types of substrates other than fabrics. Upon printing the ink composition on a substrate, e.g., fabric substrate, along with a blocked polyisocyanate crosslinker (in the ink composition or as a separate fluid) and then heating the printed image to deblock the isocyanate group and promote the crosslinking reaction between the polyurethane polymer in the ink composition and the fabric substrate, a resulting printed image can have good durability, such as washfastness, which is particularly useful for fabric substrates.

In accordance with this, the present disclosure is drawn to a printing fluid which includes from 50 wt % to 90 wt % water, from 4 wt % to 25 wt % organic co-solvent, and from 0.1 wt % to 15 wt % blocked polyisocyanate crosslinker. The blocked polyisocyanate crosslinker in this example includes multiple isocyanate groups that are blocked with benzyl amine blocking groups having the structure of Formula I, as follows:

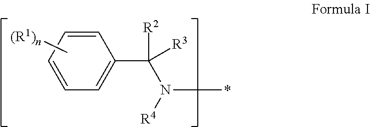

where R¹ is independently C₁-C₆-alkyl or C₆-C₁₀-cycloalkyl; R² is H, C₁-C₆-alkyl, or C₆-C₁₀-cycloalkyl; R³ is H, C₁-C₆-alkyl, or C₆-C₁₀-cycloalkyl; R⁴ is C₁-C₆-alkyl or C₆-C₁₀-cycloalkyl; and n is from 0 to 5. In one example, the printing fluid can be an ink composition including 1 wt % to 8 wt % pigment and from 1 wt % to 15 wt % polyurethane binder, with the blocked polyisocyanate present in the ink composition at from 0.1 wt % to 8 wt %. In another example, the blocked polyisocyanate crosslinker can be a blocked polyisocyanate dimer or a blocked polyisocyanate trimer, or can be a blocked polyisocyanate linear polyurethane polymer. In a more specific example, n can be 0 or 1, R² and R³ can independently be H or C₁-C₂ alkyl, and R⁴ can be n-propyl, isopropyl, n-butyl, isobutyl, or tert-butyl. The polyurethane binder in one example can have a D50 particle size from 20 nm to 500 nm. In another example, the polyurethane binder can be is a polyester-polyurethane.

In another example, a fluid set for printing includes an ink composition having from 50 wt % to 90 wt % water, from 4 wt % to 25 wt % organic co-solvent, from 1 wt % to 8 wt % pigment, and from 1 wt % to 15 wt % polyurethane binder. The fluid set in this example further includes a crosslinker composition having from 60 wt % to 95 wt % water, from 4 wt % to 25 wt % organic co-solvent, and from 1 wt % to 15 wt % blocked polyisocyanate crosslinker, which includes multiple isocyanate groups that are blocked with benzyl amine blocking groups. The benzyl amine blocking groups in this example independently have the structure of Formula I set forth above, where R¹ is independently C₁-C₆-alkyl or C₆-C₁₀-cycloalkyl; R² is H, C₁-C₆-alkyl, or C₆-C₁₀-cycloalkyl; R³ is H, C₁-C₆-alkyl, or C₆-C₁₀-cycloalkyl; R⁴ is C₁-C₆-alkyl or C₆-C₁₀-cycloalkyl; and n is from 0 to 5. In one example, the blocked polyisocyanate crosslinker can be a blocked polyisocyanate dimer or a blocked polyisocyanate trimer. In another example, the blocked polyisocyanate crosslinker can be a blocked polyisocyanate linear polyurethane polymer. In a more specific example, n can be 0 or 1, R² and R³ can independently be H or C₁-C₂ alkyl, and R⁴ can be n-propyl, isopropyl, n-butyl, isobutyl, or tert-butyl. In further detail, the polyurethane binder can have a D50 particle size from 20 nm to 500 nm, the polyurethane binder can be a polyester-polyurethane, or both.

In another example, a method of textile printing includes ejecting an ink composition onto a fabric substrate, and ejecting a blocked polyisocyanate crosslinker onto the fabric substrate. The ink composition in this example includes from 60 wt % to 90 wt % water, from 5 wt % to 25 wt % organic co-solvent, from 1 wt % to 8 wt % pigment, and from 1 wt % to 15 wt % polyurethane binder. The blocked polyisocyanate crosslinker in this example includes multiple isocyanate groups that are blocked with benzyl amine blocking groups having the structure of Formula I set forth above, where R¹ is independently C₁-C₆-alkyl or C₆-C₁₀-cycloalkyl; R² is H, C₁-C₆-alkyl, or C₆-C₁₀-cycloalkyl; R³ is H, C₁-C₆-alkyl, or C₆-C₁₀-cycloalkyl; R⁴ is C₁-C₆-alkyl or C₆-C₁₀-cycloalkyl; and n is from 0 to 5. In this example, the method further includes deblocking the blocked polyisocyanate crosslinker on the fabric substrate to generate a deblocked polyisocyanate crosslinker, and crosslinking the polyurethane binder with the deblocked polyisocyanate crosslinker on the fabric substrate. In one example, the blocked polyisocyanate crosslinker can be ejected onto the fabric substrate as part of the ink composition, wherein the blocked polyisocyanate crosslinker is included in the ink composition at from 0.1 wt % to 8 wt %. In another example, the blocked polyisocyanate crosslinker can be ejected onto the fabric substrate as a separate crosslinker composition to contact the ink composition on the fabric substrate. The crosslinker composition can include, for example, from 60 wt % to 95 wt % water, from 4 wt % to 25 wt % organic co-solvent, and from 1 wt % to 15 wt % of the blocked polyisocyanate crosslinker. In another example, deblocking the blocked polyisocyanate crosslinker on the fabric substrate can include applying heat at a temperature from 100° C. to 200° C. to the blocked polyisocyanate crosslinker on the fabric substrate in the presence of the polyurethane binder to cause crosslinking with the polyurethane binder, the fabric substrate, or both.

As a note, with respect to the ink compositions, fluid sets, and methods of textile printing described herein, more specific descriptions can be considered applicable to other examples whether or not they are explicitly discussed in the context of that example. Thus, for example, in discussing a pigment related to the ink composition, such disclosure is also relevant to and directly supported in context of the fluid sets and the methods of textile printing, and vice versa.

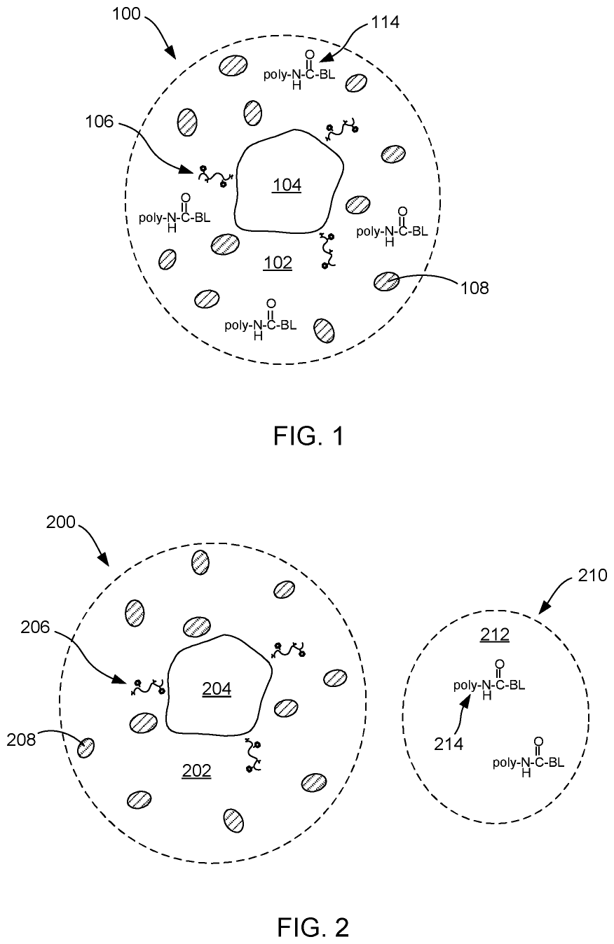

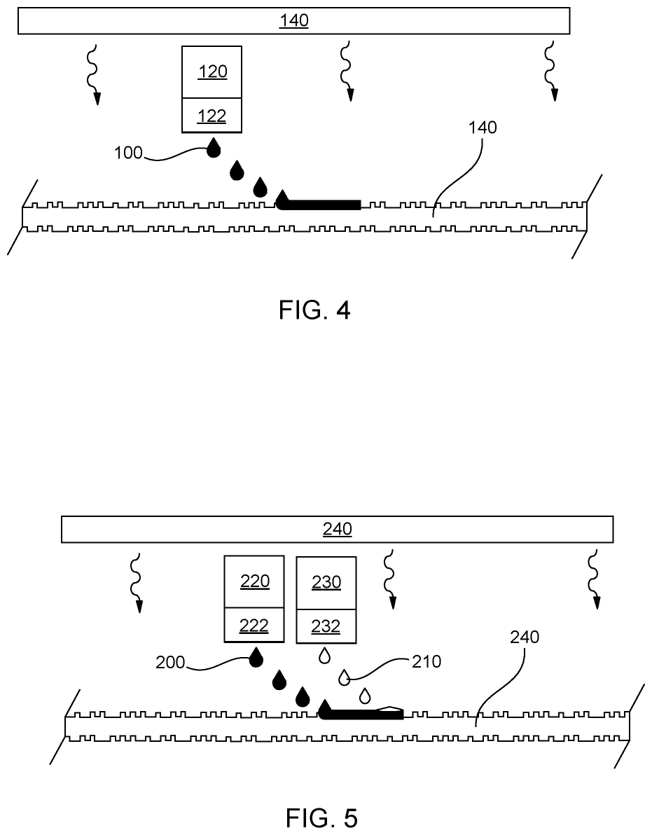

As a preliminary matter, it is noted that an ink composition which includes the blocked polyisocyanate therein (within the ink composition) is shown generally in FIG. 1 (and in use in FIG. 4). On the other hand, a fluid set is also shown in FIG. 2 (and in use in FIG. 5) where the blocked polyisocyanate is present in a separate crosslinker composition relative to the ink composition. Thus, the blocked polyisocyanate can be present in multiple types of fluids, such as an ink composition, a crosslinker composition, etc.

When referring to the blocked polyisocyanate herein, a specific class of blocking groups, shown at “BL” in the FIGS. 1 and 2, is referred to herein as having the structure notated by “Formula I.” The Formula I blocking groups are benzyl amine blocking groups independently having the structure:

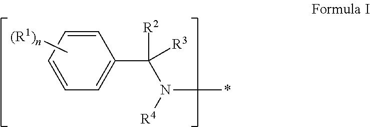

where R¹ is independently C₁-C₆-alkyl or C₆-C₁₀-cycloalkyl; R² is H, C₁-C₆-alkyl, or C₆-C₁₀-cycloalkyl; R³ is H, C₁-C₆-alkyl, or C₆-C₁₀-cycloalkyl; R⁴ is C₁-C₆-alkyl or C₆-C₁₀-cycloalkyl; and n is from 0 to 5. In this example, as asterisk (*) is used to shown where the blocking group would attach to the balance of the polyisocyanate to form the blocked polyisocyanate crosslinker. Thus, Formula I depicts a class of blocking groups and not the entire blocked polyisocyanate crosslinker.

In further detail regarding the ink compositions with blocked polyisocyanate crosslinker and the ink compositions without the blocked polyisocyanate crosslinker, there can be certain weight percentage ranges and subranges relative to both of these examples that may be the same, such as pigment content, liquid vehicle content, e.g., water, organic co-solvent, surfactant, etc., and polyurethane binder content. The blocked polyisocyanate content, on the other hand, can be included in its respective printing fluids at a different concentration range in the ink composition compared to when present in a separate crosslinker composition. This can be due in part to fluid mixing (dilution) of the crosslinker that occurs when printed separately and mixed with the ink composition on the fabric substrate, so in some examples where there is a separate crosslinker composition, more blocked polyisocyanate crosslinker may be included therein. That stated, the ranges provided herein do overlap at the upper end of the concentration range for the ink composition and at the lower end of the concentration range for the crosslinker composition, for example. In further detail, the term “polyisocyanate” refers to compounds having multiple isocyanate groups, e.g., dimers, trimers, or polymer with multiple isocyanate groups, e.g., pre-polymers or oligomers, linear polymers, branched polymers, etc. In accordance with examples herein, the blocked polyisocyanates can be used as crosslinkers with the polyurethane binder in the ink composition, with functional groups that may be present on the media substrate, e.g., fabric, etc., or any other chemical group that may be benefit from crosslinking within the printing system that includes chemistry crosslinkable with unblocked isocyanate groups.

With more specific reference to the ink composition of FIG. 1, this ink composition can include a liquid vehicle 102 (which can include water and organic co-solvent, for example) with from 1 wt % to 8 wt % pigment 104 (or pigment particles or solids) dispersed therein. The pigment can be dispersed by a dispersant 106, such as a polymer dispersant or any other dispersant technology suitable for suspending the pigment in the liquid vehicle. Example polymer dispersants can include acrylic dispersant, styrene-acrylic dispersant, styrene-maleic dispersant, or a dispersant with aromatic groups and a poly(ethylene oxide) chain, such as Esperse 100 from Evonik (Germany) and Solesperse 2700 from Lubrizol (USA), adsorbed to a surface thereof. A polyurethane binder 108 is also included in this example. The polyurethane binder can be prepared or selected so that it can be crosslinked upon deblocking of the blocked polyisocyanate 114, for example.

As shown by example in FIG. 2, a fluid set for printing can include an ink composition 200 and a crosslinker composition 210. The ink composition can include a liquid vehicle 202 (which can include water and organic co-solvent, for example) with from 1 wt % to 8 wt % pigment 204 (or pigment particles or solids) dispersed therein. The pigment can be dispersed by a dispersant 206, for example, such as a polymer dispersant or any other dispersant technology suitable for suspending the pigment in the liquid vehicle, e.g., acrylic, styrene-acrylic dispersant, styrene-maleic dispersant, or a dispersant with aromatic groups and a poly(ethylene oxide) chain such as Esperse 100 from Evonik (Germany) and Solesperse 2700 from Lubrizol (USA), adsorbed to a surface thereof. A polyurethane binder 108 is also included in the ink composition in this example. The polyurethane binder can be prepared or selected to have functional groups that can be crosslinked upon deblocking of a blocked polyisocyanate 214, which can be delivered to the fabric substrate from a separate printing fluid or crosslinker composition, shown at 210. The crosslinker composition can also include a liquid vehicle 212, which can include water and organic co-solvent, for example, and can include similar components or different components relative to the liquid vehicle of the ink composition.

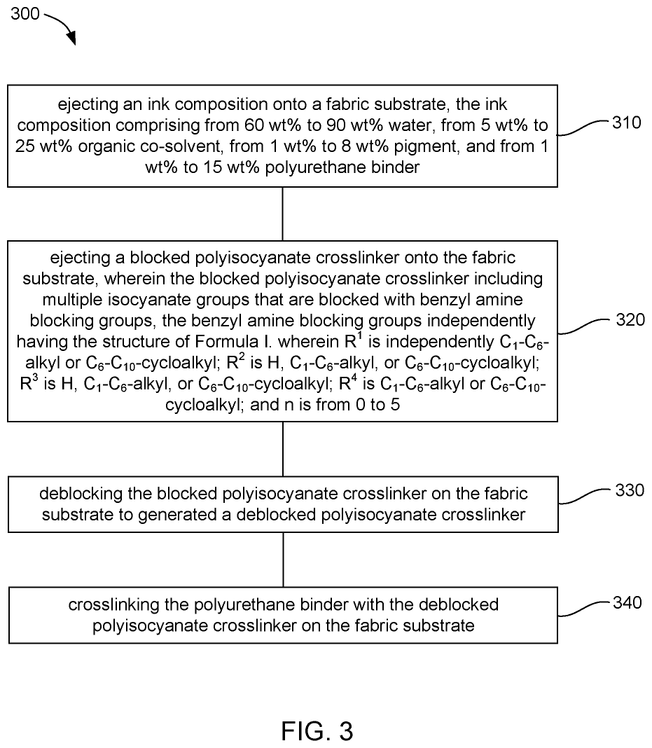

In another example, and as set forth in FIG. 3, a method 300 of textile printing can include ejecting 310 an ink composition onto a fabric substrate, the ink composition including from 60 wt % to 90 wt % water, from 5 wt % to 25 wt % organic co-solvent, from 1 wt % to 8 wt % pigment, and from 1 wt % to 15 wt % polyurethane binder; and ejecting 320 a blocked polyisocyanate crosslinker onto the fabric substrate, wherein the blocked polyisocyanate crosslinker includes multiple isocyanate groups that are blocked with benzyl amine blocking groups, the benzyl amine blocking groups independently having the structure of Formula I. In this example, with respect to Formula I set forth above, R1 can independently be C1-C6-alkyl or C6-C10-cycloalkyl; R2 can be H, C1-C6-alkyl, or C6-C10-cycloalkyl; R3 can be H, C1-C6-alkyl, or C6-C10-cycloalkyl; R4 can be C1-C6-alkyl or C6-C10-cycloalkyl; and n can be from 0 to 5. The method can further include deblocking 330 the blocked polyisocyanate crosslinker on the fabric substrate to generate a deblocked polyisocyanate crosslinker, and crosslinking 340 the polyurethane binder with the deblocked polyisocyanate crosslinker on the fabric substrate.

In accordance with the method 300 shown in FIG. 3, the ink composition can be used as shown in FIG. 1 and illustrated in use in FIG. 4. In this example, the blocked polyisocyanate crosslinker can be ejected onto the fabric substrate as part of the ink composition. Alternatively, the method 300 shown in FIG. 3 can be implemented with the fluid set of FIG. 2 and illustrated in use in FIG. 5, where the blocked polyisocyanate crosslinker is ejected onto the fabric substrate as a separate crosslinker composition to contact the ink composition on the fabric substrate. In either application example, deblocking the blocked polyisocyanate crosslinker on the fabric substrate may include applying heat at a temperature from 100° C. to 200° C. to the blocked polyisocyanate crosslinker on the fabric substrate in the presence of the polyurethane binder causing the crosslinking of the polyurethane binder.

Turning now more specifically to FIG. 4, a textile printing system is shown schematically and can include an ink composition 100, such as that shown in FIG. 1, for printing on a fabric substrate 140. For example, the ink composition can be printed from an inkjet pen 120 which includes an ejector 122, such as a thermal inkjet ejector, a piezoelectric inkjet ejector, or the like. In one example, a heating element 140, can apply heat to the fabric substrate after printing to deblock the blocked polyisocyanate, thereby causing crosslinking to occur between the polyisocyanate and the polyurethane binder and/or other solids that may be present and available for crosslinking. Temperatures for heating can range from 100° C. to 200° C., from 120° C. to 180° C., from 120° C. to 160° C., or from 130° C. to 150° C. Application time for the heat can be from 15 seconds to 10 minutes, from 30 seconds to 5 minutes, from 1 minute to 5 minutes, from 2 minutes to 5 minutes, or from 2 minutes to 4 minutes, for example.

In another example as shown in FIG. 5, a textile printing system is shown schematically and can include an ink composition 200, such as that shown in FIG. 2, for printing on a fabric substrate 240. For example, the ink composition can be ejected or printed from an inkjet pen 220 which includes an ejector 222, such as a thermal inkjet ejector, a piezoelectric inkjet ejector, or the like. The textile printing system can also include a crosslinker composition 210 to contact and react with the ink composition on the fabric substrate. The crosslinker composition can be ejected or printed from a fluidjet pen 230 which includes an ejector 232, such as a thermal fluidjet ejector. In one example, the order of ejection or application to the substrate can be the opposite of that shown, e.g., crosslinker composition printed first followed by ink composition. The inkjet pen and the fluidjet pen can be the same device or can be a different device. A heating element 240 can apply heat to the fabric substrate after printing to deblock the blocked polyisocyanate, thereby causing crosslinking to occur between the polyisocyanate and the polyurethane binder and/or other solids that may be present and available for crosslinking. Temperatures for heating can range from 100° C. to 200° C., from 120° C. to 180° C., from 120° C. to 160° C., or from 130° C. to 150° C. Application time for the heat can be from 15 seconds to 10 minutes, from 30 seconds to 5 minutes, from 1 minute to 5 minutes, from 2 minutes to 5 minutes, or from 2 minutes to 4 minutes, for example.

With more specific reference to the various components that can be present in the ink compositions and the crosslinker compositions (when applicable), in the ink composition, the pigment can be any of a number of pigments of any of a number of primary or secondary colors, or can be black or white, for example. More specifically, colors can include cyan, magenta, yellow, red, blue, violet, red, orange, green, etc. In one example, the ink composition can be a black ink with a carbon black pigment. In another example, the ink composition can be a cyan or green ink with a copper phthalocyanine pigment, e.g., Pigment Blue 15:0, Pigment Blue 15:1; Pigment Blue 15:3, Pigment Blue 15:4, Pigment Green 7, Pigment Green 36, etc. In another example, the ink composition can be a magenta ink with a quinacridone pigment or a co-crystal of quinacridone pigments. Example quinacridone pigments that can be utilized can include PR122, PR192, PR202, PR206, PR207, PR209, PO48, PO49, PV19, PV42, or the like. These pigments tend to be magenta, red, orange, violet, or other similar colors. In one example, the quinacridone pigment can be PR122, PR202, PV19, or a combination thereof. In another example, the ink composition can be a yellow ink with an azo pigment, e.g., Pigment Yellow 74 and Pigment Yellow 155.

The pigment can be dispersed by a dispersant, such as a styrene (meth)acrylate dispersant, or another dispersant suitable for keeping the pigment suspended in the liquid vehicle. For example, the dispersant can be any dispersing (meth)acrylate polymer, or other type of polymer, such as maleic polymer, for example, however, the (meth)acrylate polymer can be a styrene-acrylic type dispersant polymer, as it can promote Tr-stacking between the aromatic ring of the dispersant and various types of pigments, such as copper phthalocyanine pigments, for example. In one example, the styrene-acrylic dispersant can have a weight average molecular weight from 4,000 Mw to 30,000 Mw. In another example, the styrene-acrylic dispersant can have a weight average molecular weight from 8,000 Mw to 28,000 Mw, from 12,000 Mw to 25,000 Mw, from 15,000 Mw to 25,000 Mw, from 15,000 Mw to 20,000 Mw, or about 17,000 Mw. Weight average molecular weight (Mw) can be measured by Gel Permeation Chromatography with polystyrene standard. Example commercially available styrene-acrylic dispersants can include Joncryl® 671, Joncryl® 71, Joncryl 96, Joncryl® 680, Joncryl® 683, Joncryl® 678, Joncryl® 690, Joncryl® 296, Joncryl® 671, Joncryl® 696 or Joncryl® ECO 675 (all available from BASF Corp., Germany). Any of a number of other dispersants can be used other than these that are provided by way of example.

The term “(meth)acrylate” or “(meth)acrylic acid” or the like refers to monomers, copolymerized monomers, etc., that can either be acrylate or methacrylate (or a combination of both), or acrylic acid or methacrylic acid (or a combination of both). This can be the case for either dispersant polymer for pigment dispersion or for polyurethane binder that may include co-polymerized acrylate and/or methacrylate monomers. Also, in some examples, the terms “(meth)acrylate” and “(meth)acrylic acid” can be used interchangeably, as acrylates and methacrylates described herein include salts of acrylic acid and methacrylic acid, respectively. Thus, mention of one compound over another can be a function of pH. Furthermore, even if the monomer used to form the polymer was in the form of a (meth)acrylic acid during preparation, pH modifications during preparation or subsequently when added to an ink composition can impact the nature of the moiety as well (acid form vs. salt form). Thus, a monomer or a moiety of a polymer described as (meth)acrylic acid or as (meth)acrylate should not be read so rigidly as to not consider relative pH levels, and other general organic chemistry concepts.

In further detail, the ink compositions can also include a dispersed polyurethane binder. The polyurethane can be included in the ink composition at from 1 wt % to 15 wt %, from 2 wt % to 12 wt %, from 2 wt % to 10 wt %, or from 4 wt % to 10 wt %, for example. The polyurethane can further be dispersed in the ink composition and can have a D50 particle size from 20 nm to 500 nm, for example. In further detail, the weight average molecular weight of the polyurethane binder can be from 20,000 Mw to 500,000 Mw. In other examples, the weight average molecular weight can be from 50,000 Mw to 500,000 Mw, from 100,000 Mw to 400,000 Mw, or from 150,000 Mw to 300,000 Mw. Weight average molecular weight (Mw) can be measured by Gel Permeation Chromatography with polystyrene standard.

The acid number of the polyurethane binder can be from 0 mg KOH/g to 50 mg KOH/g, from 2 mg KOH/g to 20 mg KOH/g, or from 2 mg KOH/g to 10 mg KOH/g, for example. The term “acid value” or “acid number” refers to the mass of potassium hydroxide (KOH) in milligrams that can be used to neutralize one gram of the polymer substance (mg KOH/g), such as the polyurethane binder disclosed herein. This value can be determined, in one example, by dissolving or dispersing a known quantity of a material in organic solvent and then titrating with a solution of potassium hydroxide (KOH) of known concentration for measurement.

In further examples, the polyurethane binder can have a D50 particle size ranging from 20 nm to 500 nm, from 50 nm to 350 nm, or from 150 nm to 300 nm. The particle size of any solids herein, including the D50 particle size of the polyurethane binder, can be determined using a Nanotrac® Wave device, from Microtrac, which measures particle size using dynamic light scattering. D50 particle size can be determined using particle size distribution data generated by the Nanotrac® Wave device.

“D50” particle size is defined as the particle size at which about half of the particles are larger than the D50 particle size and about half of the other particles are smaller than the D50 particle size, by weight. Particles can be substantially spherical or have about a 1:1:1 aspect ratio, but if irregular in shape, they can be characterized for their size based on their volume averaged particle size, where the volume of the particle if spherical in shape would have a diameter that can be used to provide the volume averaged particle size. D50 particle size can thus be determined using the volume average size of particles, where 50 wt % are larger and 50 wt % are smaller than the D50 value. The particle size can be presented as a Gaussian distribution or a Gaussian-like distribution (or normal or normal-like distribution). Gaussian-like distributions are distribution curves that may appear essentially Gaussian in their distribution curve shape, but which can be slightly skewed in one direction or the other (toward the smaller end or toward the larger end of the particle size distribution range).

In one example, the polyurethane binder can be a polyester-polyurethane binder, or can be a polyether-polyurethane binder. The polyester- or polyether- polyurethane binder can be anionic in one example, and in another example, can be aliphatic including saturated carbon chains as part of the polymer backbone or side-chain thereof, e.g., C2 to C10, C3 to C8, or C3 to C6. These polyurethane binders can be described as aliphatic because the carbon chains therein are saturated and because they are devoid of aromatic moieties. An example anionic aliphatic polyester-polyurethane binder that can be used is Impranil® DLN-SD (CAS #375390-41-3; Mw 133,000 Mw; Acid Number 5.2; Tg-47° C.; Melting Point 175-200° C.) from Covestro (Germany). Alternatively, the polyester-polyurethane binder can be aromatic (or include an aromatic moiety) along with aliphatic moieties. An example of an aromatic polyester-polyurethane binder that can be used is Dispercoll U42 (CAS #157352-07-3; prepared from a polyester of phthalic acid and hexane-1,6-diol, hexanemethylene-1,6-diisocyanate (HDI), and a diamine sulfonic acid). Notably, other polyurethane types can also be used other than the polyester-type or polyether-type polyurethanes.

The ink compositions of the present disclosure can be formulated to include a liquid vehicle, which can include the water content, e.g., 50 wt % to 90 wt % or from 60 wt % to 85 wt %, as well as organic co-solvent, e.g., from 4 wt % to 25 wt %, from 5 wt % to 20 wt %, or from 6 wt % to 15 wt %. Other liquid vehicle components can also be included, such as surfactant, antibacterial agent, other colorant, etc. However, as part of the ink composition, pigment, dispersant, and the polyurethane can be included or carried by the liquid vehicle components. Notably, the liquid vehicle can be similarly formulated for use with the crosslinker composition where a crosslinker composition is included in a fluid set with an ink composition.

In further detail regarding the liquid vehicle, co-solvent(s) can be present and can include any co-solvent or combination of co-solvents that are compatible with the pigment, dispersant, and polyurethane binder. Examples of suitable classes of co-solvents include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (Ce-C12) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1, 3-propane diol (EPHD), glycerol, dimethyl sulfoxide, sulfolane, glycol ethers, alkyldiols such as 1,2-hexanediol, and/or ethoxylated glycerols such as LEG-1, etc.

The liquid vehicle can also include surfactant. In general, the surfactant can be water-soluble and may include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, and mixtures thereof. In some examples, the surfactant can include a nonionic surfactant, such as a Surfynol® surfactant, e.g., Surfynol® 440 (from Evonik, Germany), or a Tergitol™ surfactant, e.g., Tergitol™ TMN-6 (from Dow Chemical, USA). In another example, the surfactant can include an anionic surfactant, such as a phosphate ester of a C10 to C20 alcohol or a polyethylene glycol (3) oleyl mono/diphosphate, e.g., Crodafos® N3A (from Croda International PLC, United Kingdom). The surfactant or combinations of surfactants, if present, can be included in the ink composition (or the crosslinker composition) at from 0.01 wt % to 5 wt % and, in some examples, can be present at from 0.05 wt % to 3 wt %.

Consistent with the formulations of the present disclosure, various other additives may be included to provide desired properties of the ink composition or crosslinker composition for specific applications. Examples of these additives are those added to inhibit the growth of harmful microorganisms. These additives may be biocides, fungicides, and other microbial agents, which are routinely used in these types of formulations. Examples of suitable microbial agents include, but are not limited to, Acticide®, e.g., Acticide® B20 (Thor Specialties Inc.), Nuosept™ (Nudex, Inc.), Ucarcide™ (Union carbide Corp.), Vancide® (R.T. Vanderbilt Co.), Proxel™ (ICI America), and combinations thereof. Sequestering agents, such as EDTA (ethylene diamine tetra acetic acid) or trisodium salt of methylglycinediacetic acid, may be included to eliminate the deleterious effects of heavy metal impurities, and buffer solutions may be used to control the pH. Viscosity modifiers and buffers may also be present, as well as other additives to modify properties of the ink as desired.

With specific reference to the ink composition, in some examples, suitable pH ranges for the ink composition can be from pH 7 to pH 11, from pH 7 to pH 10, from pH 7.2 to pH 10, from pH 7.5 to pH 10, from pH 8 to pH 10, 7 to pH 9, from pH 7.2 to pH 9, from pH 7.5 to pH 9, from pH 8 to pH 9, from 7 to pH 8.5, from pH 7.2 to pH 8.5, from pH 7.5 to pH 8.5, from pH 8 to pH 8.5, from 7 to pH 8, from pH 7.2 to pH 8, or from pH 7.5 to pH 8.

Turning now to blocked polyisocyanate that can be present in the ink composition or in a separate crosslinker composition, the isocyanate groups of the blocked polyisocyanates can be reactive as crosslinkers with the polyurethane in the ink composition, or where printed on a fabric substrate, and may be also crosslinkable with chemical groups of the fabric. Because the isocyanate groups are blocked, they can remain stable in the ink composition and/or the crosslinker composition until unblocked on the printed substrate. Thus, the term “blocked polyisocyanate” refers to compounds with multiple isocyanate groups where a plurality of the isocyanate groups are coupled to a chemical moiety that stabilizes the isocyanate groups in the ink composition or crosslinker composition so that they remain available for reaction after printing on the fabric substrate. The chemical moiety that prevents the isocyanate groups from reacting can be referred to herein as a “blocking group.” To convert the blocked polyisocyanate to a reactive species, the blocking group can be dissociated from isocyanate groups to result in a “deblocked polyisocyanate.” Deblocking can occur by heating the blocked polyisocyanate to a temperature where deblocking or dissociation can occur, e.g., typically at from 100° C. to 200° C. for a time period of 15 seconds to 10 minutes. There may be deblocking or dissociation temperatures outside of this range, e.g., at lower temperatures, but in accordance with examples of the present disclosure, higher temperatures within this range (or even higher temperatures outside of this range), in some examples, may not just deblock the isocyanate groups, but may have the added benefit of softening or melting the polyurethane that is to be crosslinked with the deblocked polyisocyanate.

A blocked polyisocyanate can undergo deblocking to generate polyisocyanate as shown in Formula II:

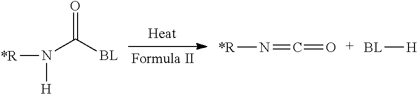

In Formula II above, R can be a linking group that connects the blocked isocyanate group shown to any organic group that includes other blocked isocyanates (as the blocked isocyanates used in accordance with the present disclosure is a blocked “poly” isocyanates, meaning that the crosslinker composition includes more than one isocyanate group). For example, R can independently include a C2 to C10 branched or straight-chained alkyl, C6 to C20 alicyclic, C6 to C20 aromatic, or a combination thereof. The asterisk (*) denotes the organic group with additional blocked isocyanate groups that extend beyond the R linking group (see Formula V below, for example, which includes the balance of a polyisocyanate trimer including two additional isocyanate groups). The generated polyisocyanate can react with hydroxyl and/or amine groups according to Formulas III and IV.

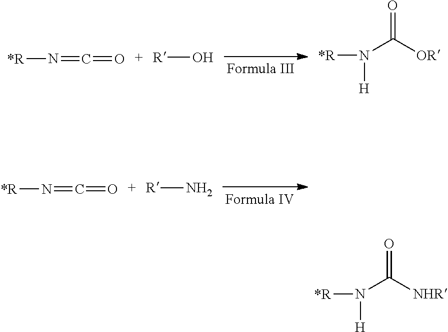

In further detail, R′ in Formula III and Formula IV can be any organic group that can be coupled to the hydroxyl or amine group to react with the polyisocyanate. In one example, R′—OH or R′—NH₂ can be a residual group present in the polyurethane binder in the ink composition, and in other examples, the R′—OH group can be present in cotton and cotton blend fabric substrates. In further detail, regarding the polyurethane binder, the binder can be crosslinked when the blocked polyisocyanate is deblocked on the fabric substrate, such as with a fabric substrate including cotton fibers, or a blend of cotton and polyester fibers, for example.

As mentioned, the blocking group that may be used in accordance with the present disclosure is shown and described as Formula I above. However, a more specific example of a blocking group is shown by example at Formula V, as follows:

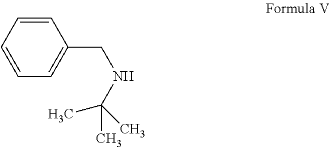

RUCO®-Coat FX8041, available from the Rudolf Group (Germany), is an example of a blocked polyisocyanate that uses the blocking group of Formula V, where H is removed and the amine is attached to the isocyanates of the polyisocyanate.

The ink compositions and/or the crosslinker compositions that include the blocked polyisocyanate crosslinker can be suitable to print on many types of substrates, but are particularly useful to print on textiles with good image quality and washfastness. Example fabric substrates that can be used include those with cotton fibers, including treated and untreated cotton substrates, as well as treated and untreated cotton/polyester blends. Other types of fabrics can be used, including various fabrics of natural and/or synthetic fibers. Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources (e.g. cornstarch, tapioca products, sugarcanes), etc. Example synthetic fibers used in the fabric substrates can include polymeric fibers such as, nylon fibers, polyvinyl chloride (PVC) fibers, PVC-free fibers made of polyester, polyamide, polyimide, polyacrylic, polypropylene, polyethylene, polyurethane, polystyrene, polyaramid (e.g., Kevlar®) polytetrafluoroethylene (Teflon®) (both trademarks of E. I. du Pont de Nemours Company, Delaware), fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation.

The fabric substrate can be in one of many different forms, including, for example, a textile, a cloth, a fabric material, fabric clothing, or other fabric product suitable to apply ink, and the fabric substrate can have any of a number of fabric structures. The term “fabric structure” is intended to include structures that can have warp and weft, and/or can be woven, non-woven, knitted, tufted, crocheted, knotted, and pressured, for example. The terms “warp” and “weft” have their ordinary meaning in the textile arts, as used herein, e.g., warp refers to lengthwise or longitudinal yarns on a loom, while weft refers to crosswise or transverse yarns on a loom.

It is notable that the term “fabric substrate” or “fabric media substrate” does not include materials commonly referred to as any kind of paper (even though paper can include multiple types of natural and synthetic fibers or mixtures of both types of fibers). Fabric substrates can include textiles in filament form, textiles in the form of fabric material, or textiles in the form of fabric that has been crafted into finished articles (e.g. clothing, blankets, tablecloths, napkins, towels, bedding material, curtains, carpet, handbags, shoes, banners, signs, flags, etc.). In some examples, the fabric substrate can have a woven, knitted, non-woven, or tufted fabric structure. In one example, the fabric substrate can be a woven fabric where warp yarns and weft yarns can be mutually positioned at an angle of about 90°. This woven fabric can include but is not limited to, fabric with a plain weave structure, fabric with twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of multiple processes.

As previously mentioned, the fabric substrate can be a combination of fiber types, e.g. a combination of natural fiber with another natural fiber, natural fiber with a synthetic fiber, a synthetic fiber with another synthetic fiber, or mixtures of multiple types of natural fibers and/or synthetic fibers in any of the above combinations. In some examples, the fabric substrate can include natural fiber and synthetic fiber, e.g., cotton/polyester blend. The amount of individual fiber types can vary. For example, the amount of the natural fiber can vary from 5 wt % to 94.5 wt % and the amount of the synthetic fiber can range from 5 wt % to 94.5 wt %. In yet another example, the amount of the natural fiber can vary from 10 wt % to 80 wt % and the synthetic fiber can be present from 20 wt % to 90 wt %. In other examples, the amount of the natural fiber can be 10 wt % to 90 wt % and the amount of the synthetic fiber can also be 10 wt % to 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa.

In one example, the fabric substrate can have a basis weight ranging from 10 gsm to 500 gsm. In another example, the fabric substrate can have a basis weight ranging from 50 gsm to 400 gsm. In other examples, the fabric substrate can have a basis weight ranging from 100 gsm to 300 gsm, from 75 gsm to 250 gsm, from 125 gsm to 300 gsm, or from 150 gsm to 350 gsm.

In addition, the fabric substrate can contain additives including, but not limited to, colorant (e.g., pigments, dyes, and tints), antistatic agents, brightening agents, nucleating agents, antioxidants, UV stabilizers, and/or fillers and lubricants, for example. Alternatively, the fabric substrate may be pre-treated in a solution containing the substances listed above before applying other treatments or coating layers.

Regardless of the substrate, whether natural, synthetic, blends thereof, treated, untreated, etc., the fabric substrates printed with the fluid sets of the present disclosure can provide acceptable optical density (OD) and/or washfastness properties. The term “washfastness” can be defined as the OD that is retained or delta E (ΔE) after five (5) standard washing machine cycles using warm water and a standard clothing detergent (e.g., Tide® available from Proctor and Gamble, Cincinnati, Ohio, USA). Essentially, by measuring OD and/or L*a*b* both before and after washing, ΔOD and ΔE value can be determined, which is essentially a quantitative way of expressing the difference between the OD and/or L*a*b* prior to and after undergoing the washing cycles. Thus, the lower the ΔOD and ΔE values, the better. In further detail, ΔE is a single number that represents the “distance” between two colors, which in accordance with the present disclosure, is the color (or black) prior to washing and the modified color (or modified black) after washing.

Colors, for example, can be expressed as CIELAB values. It is noted that color differences may not be symmetrical going in both directions (pre-washing to post washing vs. post-washing to pre-washing). Using the CIE 1976 definition, the color difference can be measured and the ΔE value calculated based on subtracting the pre-washing color values of L*, a*, and b* from the post-washing color values of L*, a*, and b*. Those values can then be squared, and then a square root of the sum can be determined to arrive at the ΔE value. The1976 standard can be referred to herein as “ΔE_{CIE}.” The CIE definition was modified in 1994 to address some perceptual non-uniformities, retaining the L*a*b* color space, but modifying to define the L*a*b* color space with differences in lightness (L*), chroma (C*), and hue (h*) calculated from L*a*b* coordinates. Then in 2000, the CIEDE standard was established to further resolve the perceptual non-uniformities by adding five corrections, namely i) hue rotation (R_{T}) to deal with the blue region at hue angles of about 275°), ii) compensation for neutral colors or the primed values in the L*C*h differences, iii) compensation for lightness (S_{L}), iv) compensation for chroma (S_{C}), and v) compensation for hue (S_{H}). The 2000 modification can be referred to herein as “ΔE₂₀₀₀.” In accordance with examples of the present disclosure, ΔE value can be determined using the CIE definition established in 1976, 1994, and 2000 to demonstrate washfastness. However, in the examples of the present disclosure, ΔE_{CIE} and ΔE₂₀₀₀ are used.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge in the art to determine based on experience and the associated description herein.

As used herein, a plurality of items, structural elements, compositional elements, and/or materials may be presented in a common list for convenience.

However, these lists should be construed as though individual members of the list are individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, but also include individual numerical values or sub-ranges encompassed within that range as if the numerical values and sub-range is explicitly recited. For example, a weight ratio range of 1 wt % to 20 wt % should be interpreted to include explicitly recited limits of 1 wt % and 20 wt %, as well as individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following are examples or illustrative of the application of the principles of the presented formulations and methods. Numerous modifications and alternative methods may be devised without departing from the present disclosure. The appended claims are intended to cover such modifications and arrangements. Thus, while the technology has been described above with particularity, the following provides further detail in connection with what are presently deemed to be the acceptable examples.

### Example 1—Preparation of Ink Compositions

Twelve (12) ink compositions were prepared in accordance with Tables 1-4, some of which included blocked polyisocyanate crosslinker and some of which did not include blocked polyisocyanate crosslinker. In Tables 1-4, weight percentages are based on solids content or active ingredient, e.g., polyurethane binder polymer, blocked polyisocyanate crosslinker content, active component in biocide, etc. pH was measured using a pH meter from Fisher Scientific (Accumet XL250). Viscosity was measured using Hydramotion Viscolite Viscometer.

TABLE 1
Black Ink Compositions (K1-K3)

| | | K1 | K2 | K3 |
|---|---|---|---|---|
| Ingredient | Category | (wt %) | (wt %) | (wt %) |
| Glycerol | Organic Co-solvent | 8 | 8 | 8 |
| LEG-1 | Organic Co-solvent | 1 | 1 | 1 |
| CRODAFOS ® N3 Acid | Surfactant/Emulsifier | 0.5 | 0.5 | 0.5 |
| (Croda International; GB) | | | | |
| SURFYNOL ® 440 | Surfactant | 0.3 | 0.3 | 0.3 |
| (Evonik; Germany) | | | | |
| ACTICIDE ® B20 | Biocide | 0.22 | 0.22 | 0.22 |
| (Thor Specialties; USA) | | | | |
| IMPRANIL ® DLN-SD | Polyurethane Binder | 6 | 6 | 6 |
| (Covestro; Germany) | (polyester-type) | | | |
| RUCO ®-Coat FX 8041 | ¹ Blocked Polyisocyanate | — | 1 | 2 |
| (Rudolf Group; Germany) | Crosslinker | | | |
| Black Pigment | Dispersed Pigment | 3 | 3 | 3 |
| Deionized Water | Water | Balance | Balance | Balance |

Initial Ink Composition Properties

| | | | |
|---|---|---|---|
| pH | 9.21 | 9.39 | 9.48 |
| Viscosity (cps) | 2.5 | 2.6 | 2.7 |

¹ Includes multiple isocyanate groups individually blocked with N-benzyl-t-butyl amine blocking groups.

TABLE 2
Cyan Ink Compositions (C1-C3)

| | | C1 | C2 | C3 |
|---|---|---|---|---|
| Ingredient | Category | (wt %) | (wt %) | (wt %) |
| Glycerol | Organic Co-solvent | 8 | 8 | 8 |
| LEG-1 | Organic Co-solvent | 1 | 1 | 1 |
| CRODAFOS ® N3 Acid | Surfactant/Emulsifier | 0.5 | 0.5 | 0.5 |
| (Croda International; GB) | | | | |
| SURFYNOL ® 440 | Surfactant | 0.3 | 0.3 | 0.3 |
| (Evonik; Germany) | | | | |
| ACTICIDE ® B20 | Biocide | 0.22 | 0.22 | 0.22 |
| (Thor Specialties; USA) | | | | |
| IMPRANIL ® DLN-SD | Polyurethane Binder | 6 | 6 | 6 |
| (Covestro; Germany) | (polyester-type) | | | |
| RUCO ®-Coat FX 8041 | ¹ Blocked Polyisocyanate | — | 1 | 2 |
| (Rudolf Group; Germany) | Crosslinker | | | |
| Cyan Pigment | Dispersed Pigment | 2.5 | 2.5 | 2.5 |
| Deionized Water | Water | Balance | Balance | Balance |

Initial Ink Composition Properties

| | | | |
|---|---|---|---|
| pH | 8.99 | 9.21 | 9.36 |
| Viscosity (cps) | 2.1 | 2.1 | 2.2 |

¹ Includes multiple isocyanate groups individually blocked with N-benzyl-t-butyl amine blocking groups.

TABLE 3
Magenta Ink Compositions (M1-M3)

| | | M1 | M2 | M3 |
|---|---|---|---|---|
| Ingredient | Category | (wt %) | (wt %) | (wt %) |
| Glycerol | Organic Co-solvent | 8 | 8 | 8 |
| LEG-1 | Organic Co-solvent | 1 | 1 | 1 |
| CRODAFOS ® N3 Acid | Surfactant/Emulsifier | 0.5 | 0.5 | 0.5 |
| (Croda International; GB) | | | | |
| SURFYNOL ® 440 | Surfactant | 0.3 | 0.3 | 0.3 |
| (Evonik; Germany) | | | | |
| ACTICIDE ® B20 | Biocide | 0.22 | 0.22 | 0.22 |
| (Thor Specialties; USA) | | | | |
| IMPRANIL ® DLN-SD | Polyurethane Binder | 6 | 6 | 6 |
| (Covestro; Germany) | (polyester-type) | | | |
| RUCO ®-Coat FX 8041 | ¹ Blocked Polyisocyanate | — | 1 | 2 |
| (Rudolf Group; Germany) | Crosslinker | | | |
| Magenta Pigment | Dispersed Pigment | 3 | 3 | 3 |
| Deionized Water | Water | Balance | Balance | Balance |

Initial Ink Composition Properties

| | | | |
|---|---|---|---|
| pH | 8.79 | 9.18 | 9.35 |
| Viscosity (cps) | 2.2 | 2.3 | 2.4 |

¹ Includes multiple isocyanate groups individually blocked with N-benzyl-t-butyl amine blocking groups.

TABLE 4
Yellow Ink Compositions (Y1-Y3)

| | | Y1 | Y2 | Y3 |
|---|---|---|---|---|
| Ingredient | Category | (wt %) | (wt %) | (wt %) |
| Glycerol | Organic Co-solvent | 8 | 8 | 8 |
| LEG-1 | Organic Co-solvent | 1 | 1 | 1 |
| CRODAFOS ® N3 Acid | Surfactant/Emulsifier | 0.5 | 0.5 | 0.5 |
| (Croda International; GB) | | | | |
| SURFYNOL ® 440 | Surfactant | 0.3 | 0.3 | 0.3 |
| (Evonik; Germany) | | | | |
| ACTICIDE ® B20 | Biocide | 0.22 | 0.22 | 0.22 |
| (Thor Specialties; USA) | | | | |
| IMPRANIL ® DLN-SD | Polyurethane Binder | 6 | 6 | 6 |
| (Covestro; Germany) | (polyester-type) | | | |
| RUCO ®-Coat FX 8041 | ¹ Blocked Polyisocyanate | 0 | 1 | 2 |
| (Rudolf Group; Germany) | Crosslinker | | | |
| Yellow Pigment | Dispersed Pigment | 3 | 3 | 3 |
| Deionized Water | Water | Balance | Balance | Balance |

Initial Ink Composition Properties

| | | | |
|---|---|---|---|
| pH | 9.21 | 9.39 | 9.48 |
| Viscosity (cps) | 2.5 | 2.6 | 2.7 |

¹ Includes multiple isocyanate groups individually blocked with N-benzyl-t-butyl amine blocking groups.

### Example 2—Preparation of Crosslinker Compositions

Two (2) colorless crosslinker compositions without colorant were prepared, both of which included a blocked polyisocyanate crosslinker (XL1 or XL2) to overprint or underprint with respect to some of the ink compositions of Tables 1-4, namely to use with the ink compositions that did not include blocked polyisocyanate crosslinker therein, for example. Weight percentages of the crosslinker compositions in Table 5 below are based on solids content of active ingredient, e.g., blocked polyisocyanate crosslinker content, active component in biocide, etc., as follows:

TABLE 5
Crosslinker Compositions with Blocked
Polyisocyanate Crosslinker (XL1 or XL2)

| | | XL1 | XL2 |
|---|---|---|---|
| Ingredient | Category | (wt %) | (wt %) |
| 2-Pyrrolidone | Organic Co-solvent | 10 | 10 |
| LEG-1 | Organic Co-solvent | 2 | 2 |
| SURFYNOL ® 440 | Surfactant | 0.3 | 0.3 |
| (Evonik - Germany) | | | |
| ACTICIDE ® B20 | Biocide | 0.2 | 0.2 |
| (Thor Specialties - USA) | | | |
| ¹ RUCO ®-Coat FX 8041 | Blocked Polyisocyanate | 4 | 8 |
| (Rudolf Group; Germany) | Crosslinker | | |
| Deionized Water | Water | Balance | Balance |

¹ Includes multiple isocyanate groups individually blocked with N-benzyl-t-butyl amine blocking groups.

### Example 3 —Washfastness of Ink Compositions on Fabric Substrates Printed With and Without Crosslinker Composition

The twelve (12) ink compositions prepared as shown in Tables 1-4 (K1-K3, C1-C3, M1-M3, and Y1-Y3) and two (2) crosslinker compositions prepared in accordance with Table 5 (XL1 and XL2) were printed in various combinations on three different types of fabrics, namely 100 wt % woven cotton, 100 wt % knitted cotton, and 50/50 (w/w) knitted cotton/polyester. In this example, when the samples were printed with a separate crosslinker composition, the crosslinker composition was overprinted with respect to ink compositions that do not include the blocked polyisocyanate crosslinker, though it is noted that the crosslinker composition could be underprinted with similar results. In printing the various ink composition samples with and without crosslinker composition, 3 drops per pixel 600 dpi durability plots, where an individual drop was about 12 ng, were printed from a thermal inkjet printhead. The crosslinker composition, when applied, was overprinted with respect to the ink composition at 1.5 drop per pixel 600 dpi (12 ng per drop), also from a thermal inkjet printhead. After printing, the printed durability plots were allowed to dry and then cured under heat (150° C. for 3 minutes).

The various twelve (12) samples were evaluated to obtain initial optical density (OD) and L*a*b* color space values, which are represented in the following tables as “pre-wash” values. Then, the printed fabric substrates were washed in a standard washing machine typically used to wash clothing, namely the WHIRLPOOL® WTW5000DW, with detergent. The washing machine settings were set as follows: Soil level “medium,” temperature “warm,” e.g., about 40° C., and wash setting “normal” with a single rinse cycle. The full washing machine cycle was repeated for 5 full washes, air drying the printed fabric substrates between wash cycles. After the five fully washing cycles, optical density (OD) and L*a*b* values were again measured for comparison. The delta E (ΔE) values were calculated using the 1976 standard denoted as ΔE_{CIE} as well as the 2000 standard denoted as ΔE₂₀₀₀. The data collected is shown in Tables 6-8, as follows:

TABLE 6
Ink Compositions Printed on 100 wt % Gray Cotton (Woven)
with and without Crosslinker Composition (XL1 or XL2)

| | Crosslinker | | | | | | |
|---|---|---|---|---|---|---|---|
| Ink | Composition | OD | OD | | | | ΔE_{(cmc)} |
| ID | ID | (Pre-wash) | (5 washes) | % ΔOD | ΔE_{CIE} | ΔE₂₀₀₀ | 2:1 |
| K1* | — | 1.119 | 0.942 | −15.8 | 9.4 | 8.1 | 8.5 |
| K2 | — | 1.127 | 1.055 | −6.4 | 3.8 | 3.5 | 4.9 |
| K3 | — | 1.128 | 1.099 | −2.6 | 3.4 | 3.2 | 4.5 |
| K1 | XL1 | 1.030 | 0.984 | −4.5 | 4.0 | 3.7 | 5.0 |
| K1 | XL2 | 1.032 | 1.035 | 0.2 | 3.3 | 3.1 | 4.5 |
| C1* | — | 1.090 | 0.871 | −20.1 | 8.1 | 5.9 | 4.0 |
| C2 | — | 1.090 | 1.016 | −6.7 | 3.5 | 2.0 | 2.0 |
| C3 | — | 1.094 | 1.051 | −3.9 | 3.5 | 1.6 | 1.9 |
| C1 | XL1 | 1.025 | 0.996 | −2.8 | 3.5 | 1.8 | 2.0 |
| C1 | XL2 | 1.037 | 1.014 | −2.2 | 3.8 | 1.6 | 2.1 |
| M1* | — | 0.985 | 0.862 | −12.5 | 7.5 | 3.7 | 3.2 |
| M2 | — | 0.992 | 0.969 | −2.3 | 4.0 | 1.7 | 2.0 |
| M3 | — | 0.998 | 0.985 | −1.3 | 3.9 | 1.7 | 1.9 |
| M1 | XL1 | 0.926 | 0.909 | −1.8 | 4.4 | 2.0 | 2.2 |
| M1 | XL2 | 0.942 | 0.928 | −1.5 | 4.3 | 1.9 | 2.2 |
| Y1* | — | 1.065 | 0.765 | −28.1 | 17.0 | 3.8 | 5.3 |
| Y2 | — | 1.069 | 0.951 | −11.0 | 5.9 | 1.3 | 1.9 |
| Y3 | — | 1.066 | 0.958 | −10.1 | 5.0 | 1.1 | 1.6 |
| Y1 | XL1 | 0.970 | 0.882 | −9.1 | 5.2 | 1.2 | 1.7 |
| Y1 | XL2 | 0.981 | 0.919 | −6.3 | 5.3 | 1.3 | 1.7 |

*Comparative Printed Samples without Blocked Polyisocyanate in either the Ink Composition or the Crosslinker Composition printed therewith.
Optical density (OD) is measured herein using an X-RITE ™ Spectrodensitometer (X-Rite Corporation), such as a Series 500 or a 938 Densitometer.

TABLE 7
Ink Compositions Printed on 100 wt % knitted Cotton
with and without Crosslinker Composition (XL1 or XL2)

| | Crosslinker | | | | | | |
|---|---|---|---|---|---|---|---|
| Ink | Composition | OD | OD | | | | ΔE_{(cmc)} |
| ID | ID | (Pre-wash) | (5 washes) | % ΔOD | ΔE_{CIE} | ΔE₂₀₀₀ | 2:1 |
| K1* | — | 1.221 | 0.799 | −34.6 | 20.4 | 17.9 | 14.6 |
| K2 | — | 1.171 | 1.078 | −8.0 | 4.9 | 4.1 | 4.7 |
| K3 | — | 1.198 | 1.146 | −4.3 | 3.4 | 3.0 | 3.9 |
| K1 | XL1 | 1.190 | 1.139 | −4.3 | 3.6 | 3.2 | 4.2 |
| K1 | XL2 | 1.204 | 1.180 | −2.0 | 3.1 | 2.8 | 3.9 |
| C1* | — | 1.156 | 0.691 | −40.2 | 19.1 | 14.4 | 8.4 |
| C2 | — | 1.147 | 1.000 | −12.9 | 4.2 | 2.9 | 2.0 |
| C3 | — | 1.135 | 1.090 | −4.0 | 2.3 | 1.3 | 1.4 |
| C1 | XL1 | 1.223 | 1.147 | −6.3 | 2.7 | 1.6 | 1.5 |
| C1 | XL2 | 1.226 | 1.171 | −4.5 | 2.5 | 1.4 | 1.4 |
| M1* | — | 1.087 | 0.705 | −35.2 | 19.9 | 10.2 | 8.0 |
| M2 | — | 1.065 | 1.025 | −3.8 | 3.8 | 1.5 | 1.8 |
| M3 | — | 1.080 | 1.051 | −2.7 | 4.2 | 1.7 | 1.9 |
| M1 | XL1 | 1.067 | 1.001 | −6.2 | 4.8 | 2.0 | 2.3 |
| M1 | XL2 | 1.069 | 1.050 | −1.8 | 4.2 | 1.8 | 1.9 |
| Y1* | — | 1.126 | 0.583 | −48.2 | 35.2 | 8.5 | 10.9 |
| Y2 | — | 1.081 | 0.952 | −11.9 | 7.7 | 1.8 | 2.4 |
| Y3 | — | 1.088 | 0.997 | −8.4 | 6.0 | 1.5 | 1.9 |
| Y1 | XL1 | 1.161 | 1.031 | −11.2 | 8.4 | 2.1 | 2.6 |
| Y1 | XL2 | 1.157 | 1.069 | −7.6 | 8.2 | 2.0 | 2.6 |

*Comparative Printed Samples without Blocked Polyisocyanate in either the Ink Composition or the Crosslinker Composition printed therewith.
Optical density (OD) is measured herein using an X-RITE ™ Spectrodensitometer (X-Rite Corporation), such as a Series 500 or a 938 Densitometer.

TABLE 8
Ink Compositions Printed on knitted 50 wt % cotton/50 wt % polyester
with and without Crosslinker Composition (XL1 or XL2)

| | Crosslinker | | | | | | |
|---|---|---|---|---|---|---|---|
| Ink | Composition | OD | OD | | | | ΔE_{(cmc)} |
| ID | ID | (Pre-wash) | (5 washes) | % ΔOD | ΔE_{CIE} | ΔE₂₀₀₀ | 2:1 |
| K1* | — | 1.151 | 0.634 | −44.9 | 24.3 | 22.6 | 16.1 |
| K2 | — | 1.086 | 0.782 | −28.0 | 12.9 | 11.5 | 8.6 |
| K3 | — | 1.098 | 0.874 | −20.4 | 9.1 | 7.9 | 6.5 |
| K1 | XL1 | 1.187 | 0.988 | −16.8 | 6.8 | 5.7 | 5.1 |
| K1 | XL2 | 1.204 | 1.046 | −13.1 | 7.4 | 6.0 | 5.5 |
| C1* | — | 1.152 | 0.701 | −39.2 | 16.6 | 12.7 | 7.3 |
| C2 | — | 1.142 | 0.968 | −15.2 | 5.2 | 3.8 | 2.4 |
| C3 | — | 1.169 | 1.020 | −12.8 | 4.1 | 3.2 | 1.9 |
| C1 | XL1 | 1.157 | 0.972 | −16.0 | 5.7 | 4.4 | 2.6 |
| C1 | XL2 | 1.196 | 1.052 | −12.1 | 5.5 | 4.1 | 2.5 |
| M1* | — | 1.041 | 0.552 | −47.0 | 28.8 | 16.0 | 11.7 |
| M2 | — | 1.008 | 0.814 | −19.2 | 9.8 | 5.0 | 4.0 |
| M3 | — | 1.022 | 0.909 | −11.1 | 5.7 | 2.8 | 2.4 |
| M1 | XL1 | 1.076 | 0.964 | −10.5 | 6.2 | 3.4 | 2.7 |
| M1 | XL2 | 1.115 | 1.026 | −7.9 | 4.7 | 2.1 | 2.1 |
| Y1* | — | 1.145 | 0.653 | −42.9 | 32.7 | 7.8 | 10.1 |
| Y2 | — | 1.119 | 0.958 | −14.3 | 8.3 | 1.8 | 2.6 |
| Y3 | — | 1.109 | 0.953 | −14.1 | 9.2 | 2.0 | 2.9 |
| Y1 | XL1 | 1.129 | 0.927 | −17.9 | 11.2 | 2.4 | 3.5 |
| Y1 | XL2 | 1.145 | 0.907 | −20.8 | 14.7 | 3.2 | 4.5 |

*Comparative Printed Samples without Blocked Polyisocyanate in either the Ink Composition or the Crosslinker Composition printed therewith.
Optical density (OD) is measured herein using an X-RITE ™ Spectrodensitometer (X-Rite Corporation), such as a Series 500 or a 938 Densitometer.

As a note, Ink Compositions K1, C1, M1, and Y1 did not include the blocked polyisocyanate crosslinker; Ink Compositions K2, C2, M2, and Y2 included 1 wt % of the blocked polyisocyanate crosslinker; and Ink Compositions K3, C3, M3, and Y3 included 2 wt % of the blocked polyisocyanate crosslinker. Thus, the Ink Composition notated above with an asterisk (*) are considered to be comparative examples, as these ink compositions did not include the blocked polyisocyanate crosslinker therein, nor were they printed in contact with a separate crosslinker composition containing the blocked polyisocyanate crosslinker.

In accordance with this, as can be seen in Tables 6-8, the poorest performing printed samples with respect to OD and washfastness in most instances were generated without the presence of a blocked polyisocyanate crosslinker. Conversely, ink compositions that included the blocked polyisocyanate crosslinker, or ink compositions without the blocked polyisocyanate crosslinker, but which were printed in contact with the crosslinker composition that included the blocked polyisocyanate crosslinker, exhibited enhanced OD and better washfastness using every metric measured in Tables 6-8.

### Example 4—Ink Composition Stability

Particle size distribution and stability data was collected for the solids, e.g., pigment, polyurethane binder particles, etc, in twelve (12) ink compositions prepared in accordance with Tables 1-4. The data collected is provided in Tables 9 and 10 below. To evaluate stability, both the D50 particle size and the D95 particle size were collected, based on volume averaged particle sizes). The D95 particle size is the size at which 95% of the particles (based on number of particles) are smaller and 5% are larger than the D95 particle size. The particle size data was initially collected (“D50 Initial” or “D95 Initial”) and then was collected again after undergoing either freeze-thaw cycling (T-cycle) or accelerated shelf-life (ASL) stress. Initial pH and Viscosity values are reported in Tables 1-4 above.

The freeze-thaw cycling (T-cycle) included 5 freeze-thaw cycles where 30 mL samples were brought to an initial temperature of 70° C. in 20 minutes, and then maintained at 70° C. for 4 hours. The samples were then decreased from 70° C. to −40° C. in 20 minutes and maintained at −40° C. for 4 hours. This process was repeated, such that the samples were subjected to a total of 5 freeze-thaw cycles. Following the fifth cycle, the samples were allowed to equilibrate to room temperature and the D50 and D95 particle sizes were tested.

Accelerated Shelf Life (ASL) included bringing the ink composition to 60° C. for 1 week, after which the ink compositions were allowed to cool to room temperature for particle size measurement.

% Δ indicates the percentile change from initial data collected compared to after T-cycle conditions or ASL stress.

TABLE 9
Freeze-Thaw (T-Cycle) Solids Particle Size Stability Data

| | D50 | D95 | D50 | D95 | | |
|---|---|---|---|---|---|---|
| Ink | Initial | Initial | T-cycle | T-cycle | % Δ D50 | % Δ D95 |
| ID | (μm) | (μm) | (μm) | (μm) | T-cycle | T-cycle |
| K1 | 0.162 | 0.464 | 0.142 | 0.307 | −12.2 | −33.8 |
| K2 | 0.160 | 0.438 | 0.145 | 0.306 | −9.6 | −30.1 |
| K3 | 0.163 | 0.398 | 0.148 | 0.313 | −9.1 | −21.4 |
| C1 | 0.099 | 0.228 | 0.092 | 0.203 | −7.0 | −10.9 |
| C2 | 0.105 | 0.263 | 0.100 | 0.229 | −5.2 | −12.9 |
| C3 | 0.103 | 0.268 | 0.095 | 0.208 | −7.9 | −22.4 |
| M1 | 0.146 | 0.394 | 0.153 | 0.352 | 4.7 | −10.7 |
| M2 | 0.150 | 0.398 | 0.135 | 0.291 | −9.6 | −26.8 |
| M3 | 0.135 | 0.335 | 0.139 | 0.298 | 3.4 | −11.2 |
| Y1 | 0.118 | 0.343 | 0.130 | 0.308 | 10.4 | −10.2 |
| Y2 | 0.136 | 0.386 | 0.137 | 0.319 | 0.7 | −17.4 |
| Y3 | 0.139 | 0.397 | 0.133 | 0.309 | −3.9 | −22.2 |

Particle size measurements were taken using a NANOTRAC ® 150 particle size system.

TABLE 10
Accelerated Shelf Life (ASL) Solids Particle Size Stability Data

| | D50 | D95 | D50 | D95 | | |
|---|---|---|---|---|---|---|
| Ink | Initial | Initial | ASL | ASL | % Δ D50 | % Δ D95 |
| ID | (μm) | (μm) | (μm) | (μm) | ASL | ASL |
| K1 | 0.162 | 0.464 | 0.134 | 0.265 | −17.3 | −43.0 |
| K2 | 0.160 | 0.438 | 0.139 | 0.279 | −12.9 | −36.4 |
| K3 | 0.163 | 0.398 | 0.147 | 0.320 | −9.5 | −19.6 |
| C1 | 0.099 | 0.228 | 0.098 | 0.210 | −0.8 | −7.5 |
| C2 | 0.105 | 0.263 | 0.093 | 0.197 | −11.4 | −25.3 |
| C3 | 0.103 | 0.268 | 0.103 | 0.227 | 0.3 | −15.5 |
| M1 | 0.146 | 0.394 | 0.132 | 0.271 | −9.7 | −31.3 |
| M2 | 0.150 | 0.398 | 0.133 | 0.271 | −11.1 | −32.0 |
| M3 | 0.135 | 0.335 | 0.129 | 0.266 | −4.5 | −20.6 |
| Y1 | 0.118 | 0.343 | 0.121 | 0.272 | 2.9 | −20.6 |
| Y2 | 0.136 | 0.386 | 0.122 | 0.273 | −10.5 | −29.3 |
| Y3 | 0.139 | 0.397 | 0.125 | 0.283 | −9.8 | −28.8 |

Particle size measurements were taken using a NANOTRAC ® 150 particle size system.

As can be seen in Tables 9 and 10, the particle size stability for the ink compositions was good both with respect to D50 and D95 under T-cycle and ASL testing protocols, with comparable data whether or not the blocked polyisocyanate crosslinker was present in the ink composition.

### Example 4—Crosslinker Composition Stability

Crosslinker Composition stability data was collected for both crosslinker compositions, namely XL1 and XL2 of Table 5. Data was collected related to pH, viscosity, and surface tension. The data was initially collected (notated as “Initial”), and then was collected again after undergoing either freeze-thaw cycling (T-cycle) or accelerated shelf-life (ASL) stress.

The freeze-thaw cycling (T-cycle) included 5 freeze-thaw cycles where 30 mL crosslinker compositions samples were brought to an initial temperature of 70° C. in 20 minutes, and then maintained at 70° C. for 4 hours. The samples were then decreased from 70° C. to −40° C. in 20 minutes and maintained at −40° C. for 4 hours. This process was repeated, such that the samples were subjected to a total of 5 freeze-thaw cycles. Following the fifth cycle, the samples were allowed to equilibrate to room temperature and the same data was recollected, e.g., pH, viscosity, and surface tension data.

Accelerated Shelf Life (ASL) included bringing the crosslinker compositions to 60° C. for 1 week, after which the ink compositions were allowed to cool to room temperature for particle size measurement.

% Δ indicates the percentile change from initial data collected compared to after T-cycle conditions or ASL stress.

Tables 11-13 provide the data collected for pH, viscosity, and surface tension, as follows:

TABLE 11
pH Stability Data for Crosslinker Compositions

| Ink | | | % Δ | | % Δ |
|---|---|---|---|---|---|
| ID | Initial pH | T-cycle pH | T-cycle pH | ASL pH | ASL pH |
| XL1 | 10.01 | 9.77 | −0.24 | 9.44 | −0.57 |
| XL2 | 9.62 | 9.66 | 0.04 | 9.45 | −0.17 |

pH was measured using a pH meter from Fisher Scientific (Accumet XL250).

TABLE 12
Viscosity (VIS) Stability Data for Crosslinker Compositions

| Ink | Initial VIS | T-cycle VIS | % Δ | ASL VIS | % Δ |
|---|---|---|---|---|---|
| ID | (cP) | (cP) | T-cycle VIS | (cP) | ASL VIS |
| XL1 | 1.4 | 1.4 | 0 | 1.5 | 7.1 |
| XL2 | 1.7 | 1.7 | 0 | 1.8 | 5.9 |

Viscosity was measured using Hydramotion Viscolite Viscometer.

TABLE 13
Surface Tension (ST) Stability Data for Crosslinker Compositions

| Ink | Initial ST | T-cycle ST | % Δ | ASL ST | % Δ |
|---|---|---|---|---|---|
| ID | (mN/m) | (mN/m) | T-cycle ST | (mN/m) | ASL ST |
| XL1 | 31.37 | 31.69 | 1.0 | 31.3 | −0.2 |
| XL2 | 32.05 | 32.25 | 0.6 | 31.79 | −0.8 |

Surface tension was measured using the Wilhelmy plate method with a Kruss tensiometer.

As can be seen in Tables 11-13, the stability data for both free-thaw cycling and accelerated shelf life is acceptable for both crosslinker compositions, with minimal changes in pH, viscosity, and surface tension after T-cycle challenge and ASL stress.

While the present technology has been described with reference to certain examples, various modifications, changes, omissions, and substitutions can be made without departing from the spirit of the disclosure. It is intended, therefore, that the disclosure be limited by the scope of the following claims.

What is claimed is:

1. A printing fluid, comprising:
from 50 wt % to 90 wt % water,
from 4 wt % to 25 wt % organic co-solvent,
from 0.1 wt % to 15 wt % blocked polyisocyanate crosslinker including multiple isocyanate groups that are blocked with benzyl amine blocking groups, the benzyl amine blocking groups independently having the structure: 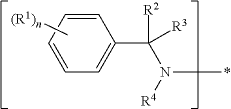
wherein R¹ is independently C₁-C₆-alkyl or C₆-C₁₀-cycloalkyl; R² is H, C₁-C₆-alkyl, or C₆-C₁₀-cycloalkyl; R³ is H, C₁-C₆-alkyl, or C₆-C₁₀-cycloalkyl; R⁴ is C₁-C₆-alkyl or C₆-C₁₀-cycloalkyl; and n is from 0 to 5.

2. The printing fluid of claim 1, wherein the printing fluid is an ink composition including 1 wt % to 8 wt % pigment and from 1 wt % to 15 wt % polyurethane binder, and wherein the blocked polyisocyanate crosslinker is included in the ink composition at from 0.1 wt % to 8 wt %.

3. The printing fluid of claim 1, wherein the blocked polyisocyanate crosslinker is a blocked polyisocyanate dimer, a blocked polyisocyanate trimer, or a blocked polyisocyanate linear polyurethane polymer.

4. The printing fluid of claim 1, wherein n is 0 or 1, R² and R³ are independently H or C₁-C₂ alkyl, and R⁴ is n-propyl, isopropyl, n-butyl, isobutyl, or tert-butyl.

5. The printing fluid of claim 1, wherein the polyurethane binder has a D50 particle size from 20 nm to 500 nm.

6. The printing fluid of claim 1, wherein the polyurethane binder is a polyester-polyurethane.

7. A fluid set for printing, comprising:
an ink composition, comprising:
from 50 wt % to 90 wt % water;
from 4 wt % to 25 wt % organic co-solvent,
from 1 wt % to 8 wt % pigment, and
from 1 wt % to 15 wt % polyurethane binder; and
a crosslinker composition, comprising:
from 60 wt % to 95 wt % water,
from 4 wt % to 25 wt % organic co-solvent, and
from 1 wt % to 15 wt % blocked polyisocyanate crosslinker including multiple isocyanate groups that are blocked with benzyl amine blocking groups, the benzyl amine blocking groups independently having the structure: 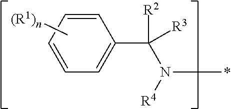
wherein R¹ is independently C₁-C₆-alkyl or C₆-C₁₀-cycloalkyl; R² is H, C₁-C₆-alkyl, or C₆-C₁₀-cycloalkyl; R³ is H, C₁-C₆-alkyl, or C₆-C₁₀-cycloalkyl; R⁴ is C₁-C₆-alkyl or C₆-C₁₀-cycloalkyl; and n is from 0 to 5.

8. The fluid set of claim 7, wherein the blocked polyisocyanate crosslinker is a blocked polyisocyanate dimer or a blocked polyisocyanate trimer.

9. The fluid set of claim 7, wherein the blocked polyisocyanate crosslinker is a blocked polyisocyanate linear polyurethane polymer.

10. The fluid set of claim 7, wherein n is 0 or 1, R² and R³ are independently H or C₁-C₂ alkyl, and R⁴ is n-propyl, isopropyl, n-butyl, isobutyl, or tert-butyl.

11. The fluid set of claim 7, wherein the polyurethane binder has a D50 particle size from 20 nm to 500 nm, the polyurethane binder is a polyester-polyurethane, or both.

12. A method of textile printing, comprising:
ejecting an ink composition onto a fabric substrate, the ink composition comprising from 60 wt % to 90 wt % water, from 5 wt % to 25 wt % organic co-solvent, from 1 wt % to 8 wt % pigment, and from 1 wt % to 15 wt % polyurethane binder;
ejecting a blocked polyisocyanate crosslinker onto the fabric substrate, wherein the blocked polyisocyanate crosslinker including multiple isocyanate groups that are blocked with benzyl amine blocking groups, the benzyl amine blocking groups independently having the structure: 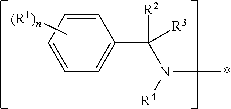
wherein R¹ is independently C₁-C₆-alkyl or C₆-C₁₀-cycloalkyl; R² is H, C₁-C₆-alkyl, or C₆-C₁₀-cycloalkyl; R³ is H, C₁-C₆-alkyl, or C₆-C₁₀-cycloalkyl; R⁴ is C₁-C₆-alkyl or C₆-C₁₀-cycloalkyl; and n is from 0 to 5;
deblocking the blocked polyisocyanate crosslinker on the fabric substrate to generate a deblocked polyisocyanate crosslinker; and
crosslinking the polyurethane binder with the deblocked polyisocyanate crosslinker on the fabric substrate.

13. The method of textile printing of claim 12, wherein the blocked polyisocyanate crosslinker is ejected onto the fabric substrate as part of the ink composition, wherein the blocked polyisocyanate crosslinker is included in the ink composition at from 0.1 wt % to 8 wt %.

14. The method of textile printing of claim 12, wherein the blocked polyisocyanate crosslinker is ejected onto the fabric substrate as a separate crosslinker composition to contact the ink composition on the fabric substrate, the crosslinker composition comprising from 60 wt % to 95 wt % water, from 4 wt % to 25 wt % organic co-solvent, and from 1 wt % to 15 wt % of the blocked polyisocyanate crosslinker.

15. The method of textile printing of claim 12, wherein deblocking the blocked polyisocyanate crosslinker on the fabric substrate includes applying heat at a temperature from 100° C. to 200° C. to the blocked polyisocyanate crosslinker on the fabric substrate in the presence of the polyurethane binder to cause crosslinking with the polyurethane binder, the fabric substrate, or both.
